(19) United States
(12) Patent Application Publication
(10) Pub. No.: US 2012/0230238 A1
(43) Pub. Date: Sep. 13, 2012

(54) Resource Setting Control for Transmission Using Contention Based Resources

(76) Inventors: Lars Dalsgaard, Oulu (FI); Troels Emil Kolding, Klarup (DK); Jeroen Wigard, Klarup (DK)

(21) Appl. No.: 13/504,630

(22) PCT Filed: Oct. 28, 2009
(86) PCT No.: PCT/EP2009/064220

§ 371 Date: May 22, 2012

(51) Int. Cl. H04W 72/04; H04W 52/02

(52) U.S. Cl. 370/311; 370/329

(57) ABSTRACT

There is proposed a mechanism for controlling a transmission of a connection quality information, like CQI, from a UE to a base transceiver station via an uplink connection. Resources of an uplink control channel for the trans-mission of the connection quality information are set for a plurality of UEs. A collision between transmissions of the connection quality information by at least two user equipments of the plurality of UEs on a same resource element is detected or predicted on the basis of input information, and a collision prevention processing is executed when such collision is detected or predicted.

### BACKGROUND OF THE INVENTION

1. Field of the Invention

The present invention relates to a mechanism for controlling a transmission of connection quality information from a user equipment to a base transceiver station via an uplink connection. In particular, the present invention is related to a mechanism for controlling a transmission of connection quality information via an uplink control channel wherein a collision detection and a collision prevention are executed.

2. Related Prior Art

In the last years, an increasing extension of communication networks, e.g. of wire based communication networks, such as the Integrated Services Digital Network (ISDN), or wireless communication networks, such as the cdma2000 (code division multiple access) system, cellular 3rd generation (3G) communication networks like the Universal Mobile Telecommunications System (UMTS), cellular 2nd generation (2G) communication networks like the Global System for Mobile communications (GSM), the General Packet Radio System (GPRS), the Enhanced Data Rates for Global Evolutions (EDGE), Long Term Evolution (LTE) or other wireless communication system, such as the Wireless Local Area Network (WLAN) or Worldwide Interoperability for Microwave Access (WiMax), took place all over the world. Various organizations, such as the 3^{rd} Generation Partnership Project (3GPP), Telecoms & Internet converged Services & Protocols for Advanced Networks (TISPAN), the International Telecommunication Union (ITU), 3^{rd} Generation Partnership Project 2 (3GPP2), Internet Engineering Task Force (IETF), the IEEE (Institute of Electrical and Electronics Engineers), the WiMax Forum and the like are working on standards for telecommunication network and access environments.

Generally, for properly establishing and handling a communication connection between network elements such as a (mobile) user equipment (UE) and another communication equipment or user equipment, a database, a server, etc., one or more intermediate network elements such as base transceiver stations, control network elements, support nodes, service nodes and interworking elements are involved. A plurality of UEs may be connected to one or more base transceiver stations which is generally a fixed station, for example an access point (AP), a base station (BS), an evolved NodeB (eNB) or the like. In the following, the base transceiver station is assumed to be an eNB implemented in an LTE environment.

Generally, a communication from the UE to the eNB is referred to as uplink communication (UL), and communication from the eNB to the UE is referred to as downlink communication (DL). The eNB may comprise radio frequency transmitter(s) and the receiver(s) used to communicate directly with the UE. Similarly, each UE may comprise radio frequency transmitter(s) and receiver(s) used to communicate directly with the eNB.

For controlling a communication connection, it is necessary to exchange control information like control information bits in uplink and downlink directions. For example, connection quality information like an indicator of downlink channel quality (CQI) is transmitted in the uplink to support UE scheduling in the downlink. Such uplink control information is transmitted, for example, by means of a so-called physical uplink control channel (PUCCH) or a physical uplink shared channel (PUSCH), as defined by 3GPP for evolved universal terrestrial radio access (EUTRA) or 3GPP LTE.

PUCCH is designed to provide a high transmission reliability and provides dedicated resources for user equipments. PUSCH may be dynamically scheduled, i.e. time-frequency resources of PUSCH may be re-allocated for every sub-frame (wherein the UE is informed of the allocation of resources by using a so-called Physical Downlink Control Channel (PDCCH)), or resources of the PUSCH may be allocated semi-statically, i.e. semi-persistent scheduled. The idea of PUSCH is that any given time-frequency PUSCH resource may be used by any UE (e.g. depending on scheduling).

In the following, an uplink control channel, such as PUCCH, may be a frequency hopping resource located symmetrically in both edges of a system bandwidth. An uplink shared channel, such as PUSCH, may be allocated in any place of the system bandwidth, possibly also overlapping with PUCCH. Hence, PUCCH and PUSCH may be different in such that frequency resources allocated for PUCCH are found at the two extreme edges of the uplink frequency spectrum while frequency resources used for PUSCH are in between. PUSCH is designed for transmission of user data, and is generally scheduled with less stand-alone sub-frame reliability than PUCCH.

The Channel Quality Indicator (CQI) is a measurement of the communication quality of wireless channels. CQI is a value representing, for example, the channel quality for a given number of physical resource blocks (PRBs) in an LTE based system. The CQI information may be used for frequency selective scheduling, i.e. for scheduling the users under most favourable conditions. The gain of such a frequency selective scheduling may be significant and is, for example, in the order of 50% in LTE systems with 10 MHz of bandwidth in case a corresponding number of users is actine.

CQI measurement is sent by the UE to the eNB in the uplink direction. There are proposed various ways how the CQI is transmitted or reported. For example, according to current LTE related specifications, there are defined a so-called periodic mode and a so-called aperiodic (also referred to as scheduled CQI) mode

In case of periodic reporting mode, two cases are differentiated. In the first case, if the UE has no other simultaneous transmission of user data, the CQI is sent on (dedicated) resources of PUCCH. In the second case, if UE has uplink transmission ongoing in the current transmission time interval (TTI), resources of PUSCH are used. On the other hand, in case of a scheduled CQI mode, reporting data is always sent on the PUSCH.

In order to save energy at the UE side, energy saving procedures may be employed setting the UE temporarily into an inactive or sleeping state. For example, Discontinuous Reception (DRX) is employed in E-UTRAN RRC (Evolved UMTS Terrestrial Radio Access Network Radio Resource Control) Connected mode in order to enable prolonged mobile battery life in RRC Connected mode. In this scheme, it is specified that the UE only monitors the PDCCH within its active DRX period. Moreover the network should only schedule the UE with resource via the PDCCH during the UE's active time (i.e. the specified time when the UE monitors the PDCCH). This functionality enables that the UE does not have to continuously monitor the PDCCH for potentially assigned resources on PDSCH (Physical Downlink Shared Channel) and/or PUSCH. When the UE is in DRX mode, it is proposed that the periodic CQI reporting is masked by a so-called On-Duration period. The On-Duration defines the time during which the UE being in the DRX cycle monitors downlink control channels, such as the PDCCH, followed by a possible period of inactivity. When masking the CQI reporting by the On-Duration, it is possible to re-use PUCCH channels by different DRX users as long as they are never active the same time which is guaranteed by On-Duration. This allows for multiple periodic CQI report per DRX period On-Duration which also improves the performance of the DRX users.

However, the masking based on On-Duration is not always available or possible. For example, there are networks where such a masking is only governed by Active Time. Active Time defines the time during which the UE is awake and monitors the PDCCH. When DRX is configured by a higher layer, this includes the On-Duration, the time the UE is continuously monitoring the PDCCH while a DRX Inactivity Timer (number of consecutive TTIs during which the UE monitors the PDCCH after successfully decoding a PDCCH indicating an initial UL or DL user data transmission for this UE) has not expired and the time the UE is continuously monitoring the PDCCH while a DRX Retransmission Timer (number of consecutive TTIs during which the UE monitors the PDCCH for as soon as a DL retransmission is expected by the UE) has not expired. In other words, the Active Time consists of the time instances where the UE is in non-DRX mode. Hence, in such a case, the only way to achieve an on-duration masking in is to set a periodic CQI reporting interval to the same periodicity as the regular DRX pattern. This basically means that periodic CQI is not available during the DRX user's active time, and if On-Duration is long, only a single periodic CQI report will be available. Therefore, in this case, it is necessary that the network control element, such as the eNB, schedules any further CQI report on PUSCH which is however expensive on uplink bandwidth and downlink control channel (PDCCH) resources as the scheduling information is transmitted to the UE via PDCCH.

On the other hand, the amount of PUCCH resources, which are usable for a periodic CQI reporting, is configurable by the network (e.g. by the eNB) and is signalled in the system information towards the UE. The UEs are provided with the location of the respective PRBs among the PUCCH resources (dedicated resources), which are then usable for transmitting respective CQI reporting, together with the periodicity of CQI reporting. Thus, when a certain number of DRX users (UEs) is provided, it is possible for the network to allocate sufficient PUCCH resources and to sufficiently slow down the respective CQI reporting rate so that all UEs are able to safely transmit their CQI reports without collisions. However, due to such a hard-reservation of bandwidth for PUCCH reporting, uplink spectral efficiency is deteriorated. Furthermore, this scheme leads also to resource waste as those PUCCH resources will be often idle as the respective UE may not be active. Further, due to the limited amount of resources available on PUCCH, such a mechanism is not feasible in case the number of users exceeds a specific number.

DRX mode setting, for example in LTE, may be based on dynamic parameters, e.g. Inactivity Timer, Short DRX, MAC (Media Access Control) sleep command, and the like. However, due to this dynamic setting possibility, it is difficult to predict when a UE is active and thus to configure CQI reporting correspondingly so that it does not collide with other users. Furthermore, the network's ability to predict activity periods is further complicated by other features, such as that the number of UEs being in the cell may change over time (according to traffic and mobility pattern). Additionally, from a QoS (Quality of Service) and system performance point of view, it is tried by the DRX mode to put UEs to sleep as often as possible (for example, a corresponding inactivity timer is used in DRX schemes). This, however, complicates also the prediction regarding an active time of a UE. Moreover, by the use of DRX short cycle (short DRX) scheme, which may dynamically open up more resources for activity, prediction is complicated further.

Thus, it is difficult to control a transmission of connection quality information, such as COI, by setting resources in available uplink channels in such a manner that resources in the downlink and the uplink directions are not wasted and a throughput is at a sufficiently high level, in particular in case a UE is not always active, such as in a DRX mode.

### SUMMARY OF THE INVENTION

Thus, it is an object of the invention to provide an improved mechanism for controlling transmission of connection control information in the uplink direction. Specifically, it is an object of the invention to provide an improved mechanism by means of which uplink channel resources, for example for UEs in DRX mode, are set such that the cell throughput and resource usage in the downlink and the uplink is improved at the same time.

These objects are achieved by the measures defined in the attached claims.

According to an example of the proposed solution, there is provided, for example, a method comprising controlling a transmission of a connection quality information from a user equipment to a base transceiver station via an uplink connection, setting resources of an uplink control channel for a plurality of user equipments, wherein resource elements of the resources of the uplink control channel are to be used for the transmission of the connection quality information by each of the plurality of user equipments, detecting a collision between transmissions of the connection quality information by at least two user equipments of the plurality of user equipments on a same resource element of the set resources of the uplink control channel, and executing a collision prevention processing when a collision is detected.

Furthermore, according to an example of the proposed solution, there is provided, for example, an apparatus comprising a controller configured to control a transmission of a connection quality information from a user equipment to a base transceiver station via an uplink connection, a resource setter adapted to set resources of an uplink control channel for a plurality of user equipments, wherein resource elements of the resources of the uplink control channel are to be used for the transmission of the connection quality information by each of the plurality of user equipments, a collision detector configured to detect a collision between transmissions of the connection quality information by at least two user equipments of the plurality of user equipments on a same resource element of the set resources of the uplink control channel, and a collision preventor configured to execute a collision prevention processing when a collision is detected.

According to further refinements, there may be comprised one or more of the following features:
the setting of the resources may comprise an overbooking in the uplink control channel with regard to the number of user equipments of the plurality of user equipments, wherein the overbooking may be based on a specific overbooking factor; furthermore, the specific overbooking factor may be determined on the basis of parameters comprising at least one of a traffic pattern value, an activity factor value, a value indicating quality of service constraints, and values indicating a discontinuous reception setting of the plurality of user equipments;
the collision detection may comprise an estimation of a possible collision beforehand by considering input information regarding the transmission of the connection quality information of each of the plurality of user equipments; furthermore, the input information may comprise at least one of an indication regarding an active time of each of the plurality of user equipments, information of timer settings for the plurality of user equipments, information regarding scheduling of the plurality of user equipments, and information regarding the settings of the plurality of user equipments concerning the transmission of the connection quality information to the base transceiver station;
the collision prevention processing may comprise at least one of a first processing comprising a change of a setting of resources for a transmission of the connection quality information by at least one user equipment of the plurality of user equipments from a resource at the uplink control channel to a resource at an uplink shared channel, and a second processing comprising a change of a configuration of at least one of the plurality of user equipments regarding the transmission of the connection quality information; the first processing may further comprise a selection of one of the at least two user equipments involved in the collision between transmissions of the connection quality information, wherein a setting of the resources for the transmission of the connection quality information of the selected user equipment may be maintained;
a collision probability may be determined on the basis of a result of the detecting of the collision;
furthermore or alternatively, a collision probability may be determined on the basis of a result of the detecting of the collision, wherein the second processing may be executed in the collision prevention processing when the collision probability exceeds a predetermined threshold;
the uplink connection may comprise at least one of a physical uplink control channel and a physical uplink shared channel;
the connection quality information may be a channel quality indicator (CQI);
the detection of a collision may be executed on a media access control layer.

Moreover, according to another example of the proposed solution, there is provided, for example, a computer program product for a computer, comprising software code portions for performing the steps of the above defined method, when said product is run on the computer. The computer program product may comprise a computer-readable medium on which said software code portions are stored. Furthermore, the computer program product may be directly loadable into the internal memory of the computer and/or transmittable via a network by means of at least one of upload, download and push procedures.

By virtue of the proposed solutions, it is possible to optimize a cell throughput in the downlink and the uplink direction at the same time. By using overbooking of resources at the uplink control channel, such as PUCCH, the resources thereof can be used more efficiently. Hence, as the basic issue, it is possible to configure the connection quality reporting at the UE side such that fast and frequent CQI reporting for UEs, specifically those being in a DRX mode, is set so that they have good scheduling performance whenever they are in active time, while at the same time a minimal possible uplink overhead is produced. Thus, when several UEs in DRX are determined on the basis of their traffic characteristics and configured DRX parameters as having not often an overlap between respective active times, it is possible to configure settings regarding transmission of connection quality information such that they may share the same PUCCH resources for CQI reporting.

By providing a collision detection based on traffic characteristics and configured DRX parameters of the UEs monitored, possible future collisions between two or more UEs at the same resource can be recognized beforehand, so that suitable measures may be taken to avoid or prevent such collisions. Hence, the reliability of connection quality information transmission is improved.

Furthermore, by providing different collision prevention measures, for example one for short term measures and one for long term measures, a suitable collision prevention processing can be executed (necessary configuration processing and signaling load caused by long term measures may be only accepted in case the collision scenario is severe or can not be overcome by only short term measures being less complicated). Hence, system flexibility can be improved while the reliability of transmission can be further increased.

By determining a collision probability value, it is possible to improve a selection of a corresponding collision prevention measure (such as short term or long term measures). Thus, it is possible to accurately determine which collision prevention measure is to be taken, for example on the basis of a number of times a collision may occur, so that the system performance can be further improved.

Furthermore, the proposed mechanism can be easily implemented in existing networks, for example in existing eNBs of an LTE system.

Additionally, the transmission control mechanism is useful in case of an asymmetric traffic as it allows an efficient usage of uplink control channel and uplink shared channel resources, such as PUCCH and PUSCH resources, since the monitoring of collisions allows to set the overbooking factor such that the asymmetry of the traffic can be considered.

The above and still further objects, features and advantages of the invention will become more apparent upon referring to the description and the accompanying drawings.

### BRIEF DESCRIPTION OF THE DRAWINGS

FIG. 1 shows a flow chart illustrating a transmission control scheme for connection quality information according to an example of an embodiment of the invention.

FIG. 2 shows a flow chart illustrating a collision detection and prevention scheme executed in a transmission control according to an example of an embodiment of the invention.

FIG. 3 shows a diagram illustrating resources in a frame structure comprising resources of an uplink control channel and resources of an uplink shared channel usable according to an example of an embodiment of the invention.

FIG. 4 shows a block circuit diagram illustrating a configuration of a base transceiver station capable of controlling a transmission of connection quality information and setting corresponding resources according to an example of an embodiment of the invention.

### DESCRIPTION OF PREFERRED EMBODIMENTS

In the following, examples and embodiments of the present invention are described with reference to the drawings. For illustrating the present invention, the examples and embodiments will be described in connection with a communication system which may be based on a 3GPP LTE where an eNB is used as a base transceiver station. However, it is to be noted that the present invention is not limited to an application in such a system or environment but is also applicable in other communication systems, connection types and the like.

A basic system architecture of a communication network in which a control mechanism according to an example of an embodiment of the invention may be implemented may comprise a commonly known architecture of a wired or wireless access network subsystem. Such an architecture comprises one or more access network element or control units, radio access network elements, or base transceiver stations, with which a user equipment is capable to communicate via one or more channels for transmitting several types of data. The general functions and interconnections of these elements are known to those skilled in the art and described in corresponding specifications so that a detailed description thereof is omitted herein. However, it is to be noted that there are provided several additional network elements and signaling links used for a communication connection or a call between user terminals and/or network elements than those described in detail herein below.

Furthermore, the network elements and their functions described herein may be implemented by software, e.g. by a computer program product for a computer, or by hardware. In any case, for executing their respective functions, correspondingly used devices, such as a base transceiver station or an eNB, comprise several means and components (not shown) which are required for control, processing and communication/signaling functionality. Such means may comprise, for example, a processor unit for executing instructions, programs and for processing data, memory means for storing instructions, programs and data, for serving as a work area of the processor and the like (e.g. ROM, RAM, EEPROM, and the like), input means for inputting data and instructions by software (e.g. floppy diskette, CD-ROM, EEPROM, and the like), user interface means for providing monitor and manipulation possibilities to a user (e.g. a screen, a keyboard and the like), interface means for establishing links and/or connections under the control of the processor unit (e.g. wired and wireless interface means, an antenna, etc.) and the like.

According to an example of an embodiment of the invention, a mechanism for controlling a transmission of connection quality information from a user equipment UE to a base transceiver station (e.g. an eNB) via an uplink connection is provided wherein a collision detection and a collision prevention are executed.

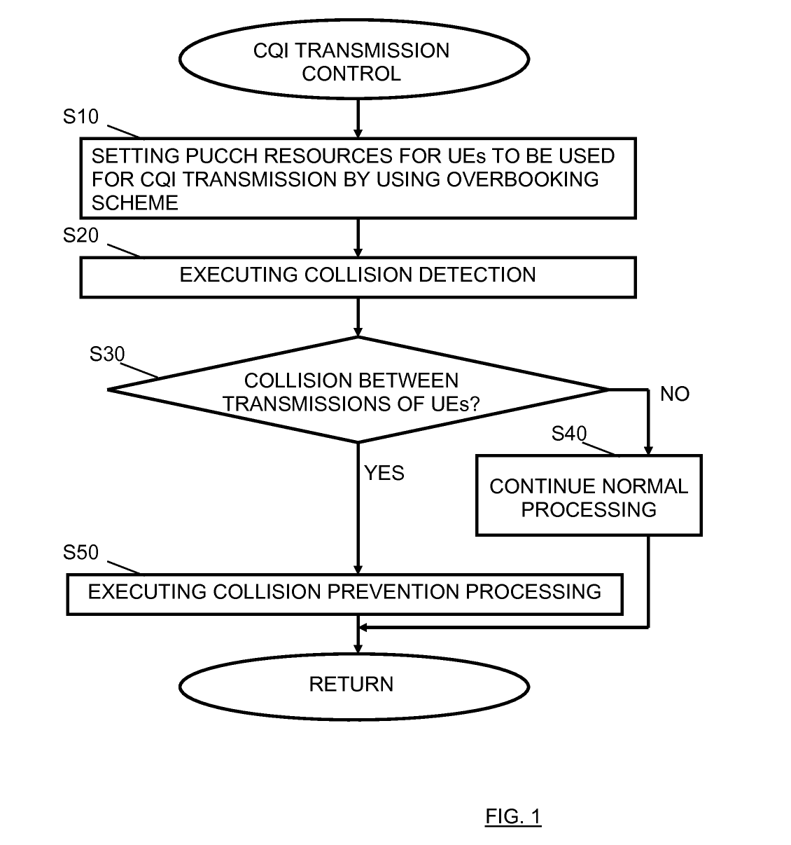

FIG. 1 shows a flow chart illustrating an example of a corresponding control procedure for a transmission of CQI as connection control information.

In step S10 according to FIG. 1, as a (initial) transmission setting, the network e.g. by means of the base trans-ceiver staton or eNB, performs a resource setting in which the resources of a specific channel, such as PUCCH, are allocated to the UEs which have to send the connection quality information (like CQI) in such a manner that the available resources on PUCCH, for example, are overbooked. In other words, all available resource elements on PUCCH are assigned to the UEs wherein one or more of the available resource elements on PUCCH are assigned to more than one UE (for example in case more UEs are present than resource elements on PUCCH). The respective UEs are informed about the assigned (or dedicated) resource (i.e. a resource element index or the like) of the PUCCH by a corresponding signaling and uses the set resource element (on PUCCH) for periodic CQI reporting, for example.

With regard to the overbooking, the network (for example the eNB as a corresponding control element) assigns the available resources on PUCCH by considering a specific factor which may be referred to as overbooking factor. The overbooking factor can be set in the eNB statically (i.e. a fixed value) or based on dynamically changing parameters provided by means of corresponding input information. This input information may comprise, for example, at least one of the following: traffic patterns, including activity factors, of the UEs connected to the network, QoS constraints, DRX settings of the connected UEs, and the like. For example, if the traffic pattern is such that a certain percentage of the traffic is only sending a PING every 30 seconds then these UEs are likely to be in DRX mode (how much depends on the parameters); thus, the overbooking (i.e. the overbooking factor) can be set accordingly (the more UEs are assumed to be in DRX mode, the higher the overbooking factor may be). The exact amount of overbooking may depend on the amount of traffic like this, the other traffic (not related to DRX), DRX parameters, etc.

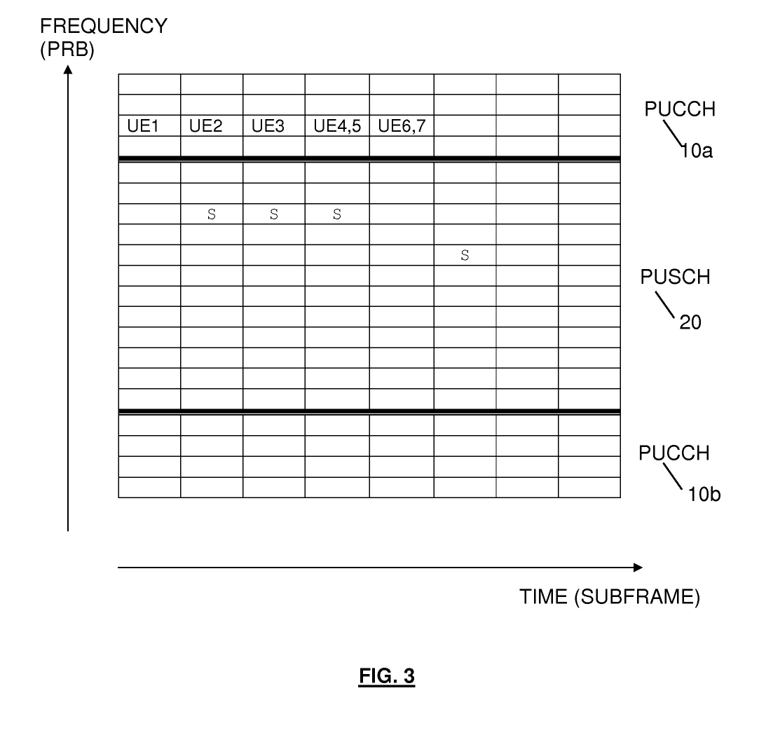

A result of the overbooking is illustrated in FIG. 3. FIG. 3 shows a diagram illustrating resources in a frame structure comprising resources of an uplink control channel (PUCCH) 10a/b (as described above, the PUCCH may be located at both edges of an available spectrum) and resources of an uplink shared channel (PUSCH) 20 within a specific number of sub-frames (time). In the ordinate direction of the frame structure of FIG. 3, the elements differ in frequency (Physical Resource Blocks (PRB)), while in the abscissa direction, the fields differ in their allocation to different sub-frames (transmission time intervals). The upper and lower edges of the frame (limited by a bold line, respectively) represent the PUCCH, while the intermediate portion represents the PUSCH. It is to be noted that this picture represents just an example of resource split between PUCCH and PUSCH. The proposed transmission control scheme is not limited to any specific resource split between PUSCH and PUCCH.

Basically, it is to be noted that the allocation or reservation of resources on PUCCH and PUSCH may be done dynamically, for example by means of a signaling via the PDCCH, wherein for each sub-frame it is decided by the network control element, like the eNB, which resource elements (i.e. fields) are available for a CQI transmission. The number of fields may be different and changed from frame to frame.

In the case of FIG. 3, as an illustrative example, five fields in the PUCCH 10a are allocated to different user equipments UE1 to UE7. As shown in FIG. 3, two of the five fields are allocated to more than one UE, i.e. to UE4/UE5 and UE6/UE7, respectively, according to the overbooking processing.

Also shown in FIG. 3 are resource elements in the PUSCH section 20 (indicated by “S”) which are assigned according to this illustrative example for a possible usage for CQI reporting via PUSCH.

It is to be noted that an overbooking scheme will possible lead to collisions once in a while. In other words, as in the examples of FIG. 3, it is possible that due to the changing settings of UEs, such as UE4, UE5 or UE6, UE7, it is possible that in the same resource element both assigned UEs intend to send a CQI reporting at the same time.

Therefore, referring back to FIG. 1, according to an example of an embodiment of the invention, a collision detection is executed in step S20.

Such a collision detection may be executed, for example, in a corresponding system layer where data necessary for the detection (or prediction) of collisions is present. For example, in an LTE environment, the collision detection is conducted in a MAC layer where information regarding the scheduling activity of all UEs is contained.

In step S30, it is determined whether a collision between transmissions of at least two UEs occurs at any of the resource elements (PUCCH resources) in question. If the determination in step S30 is negative, i.e. there is no collision to be expected, the processing of the transmission control is conducted in a usual manner, i.e. the current settings regarding the connection quality information transmission is kept and the information are received via the pre-set resources (step S40). Furthermore, the trans-mission control is repeated in the next control interval (e.g. next TTI).

Otherwise, in case the determination in step S30 is positive, i.e. when a collision is detected between e.g. users (for example two UEs being in DRX mode), step S50 is executed. In step S50, a collision prevention processing is executed in which, according to the input parameters considered in step S20, for example, a change of the current settings for the transmission of connection quality information at at least one of the UEs involved in the collision is executed so as to avoid that the concurrent transmissions of the CQI, for example, occurs.

Thereafter, the transmission control is repeated in the next control interval (e.g. next TTI).

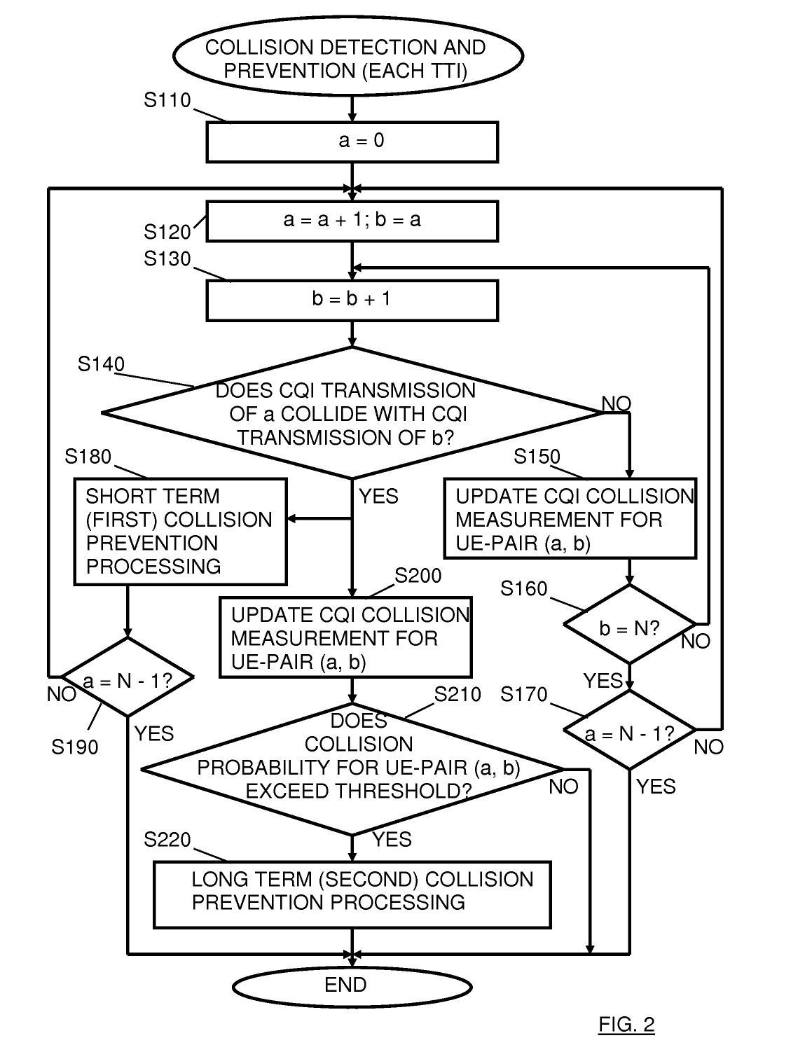

In FIG. 2, a more detailed example of an embodiment of the invention is shown which illustrates in particular the procedure regarding the collision detection and collision prevention conducted in the transmission control scheme. The procedure illustrated in FIG. 2 corresponds basically to the procedure parts of FIG. 1 according to steps S20 to S50, for example.

The procedure according to FIG. 2 regarding the collision detection and collision prevention is conducted and repeated, for example, in each TTI. In step S110, the processing is initialized by setting an index a representing a (first) UE to be monitored to zero. In step S120, the index a is incremented by 1, and an index b representing a (second) UE to be monitored (and to be compared with the UE represented by index a) is set to the same value. In step S130, the index b is further incremented by 1 (so as to have now a different (second) UE).

In step S140, it is determined whether a CQI transmission of the UE identified by the index a collides with a CQI transmission of the UE identified by the index b. This determination, i.e. the collision detection or prediction, may be executed in the MAC layer. Specifically, a collision detection component may be provided whose goal is to detect possible future collisions of CQI reports from different UEs (like a and b), which are to be sent on the same PUCCH resources. For this detection, it is necessary to keep track of several parameters or input information, such as the respective active time of the UEs (all UEs connected to the eNB, for example, including dynamic DRX timers, whether the UEs are being scheduled, etc.) and CQI settings of all UEs (in particular periodicity of CQI transmission, but also other parameters like timing of CQI transmission etc.). On the basis of this input information, the collision determination processing in step S140 is able to estimate whether or not possible CQI reporting collisions between different users may occur on the same resource element.

If the determination in step S140 is negative, the processing proceeds to step S150 where a CQI collision measurement for the UE pair under investigation (UE corresponding to a and b) is updated. The CQI collision measurement may comprise, for example, a determination of a collision probability value indicating a probability that a collision between the UEs at the dedicated resource element happens. In the case of step S150, as no collision is detected, the collision probability may be lowered (or at least kept constant). This can be done for example by a filtered version of the measurement.

After step S150, in step S160, it is checked whether the index b (corresponding to the second UE) has reached the number of N (total number of UEs connected to the eNB and/or to be monitored). If N is not reached, the processing returns to step S130 in which the index b is incremented by 1 so as to detect the next pair of UEs. Otherwise, in case N is reached, step S170 is executed in which it is checked whether the index a is equal to (N−1). If yes, the processing ends (in this TTI). If no, the processing returns to step S120 so as to detect a further UE pair (two new UEs).

On the other hand, in case in step S140 a collision is detected/predicted, two parallel processing branches are followed. In the first branch, in step S180, a first processing for preventing a collision is executed which is also referred to as a short term collision prevention processing.

In this short term collision prevention processing, basically, actions are taken to avoid the collision or minimize the impact of it. For example, if a collision is detected in step S140, it is avoided by changing a resource setting for one of the UEs (identified by a or b), for example by scheduling the UE corresponding to b in uplink, resulting in that the periodic CQI reporting is moved to PUSCH. Alternatively, scheduled CQI reporting may be set for the UE in question, which always uses PUSCH resources and overrides periodic CQI reporting mode. In both cases, the PUCCH resource usage of one of the colliding UEs is changed to a PUSCH resource usage.

In other words, whenever a collision is detected, according to the example of an embodiment depicted in FIG. 2, the short term collision prevention processing is conducted. As a further part of this short term processing, a corresponding element which may be part of a packet scheduler or the like, decides which one of the UEs in question can still use the original (i.e. PUCCH) resources for the CQI trans-mission and which UE(s) has (have) to move to PUSCH based transmission. This decision may be conducted in a random manner, or based on further considerations. For example, when it is decided which UE(s) has (have) to be moved to PUSCH, it may be considered which user (UE) would get the uplink scheduling grant or which user (UE) could benefit from a PUSCH-carried CQI report (e.g. if scheduled CQI is decided), for example based on UL buffer contents (when data are present in UL buffer, PUSCH resources may be needed in any case), a priority setting for the respective UE, or the like. Based on this consideration, the selection of the UEs regarding remaining on PUCCH or changing to PUSCH can then be executed.

When it is decided in the short term collision prevention processing in step S180 which UE(s) have to be moved, a corresponding UL grant is transmitted to the corresponding UE(s), for example by using PDCCH resources, i.e. either a data grant so that the periodic CQI is moved to PUSCH or a scheduled CQI grant, depending on which type of resource change is decided in step S180. Additionally, a CQI status indication is updated so as to indicate that the CQI is reported via PUSCH, for example, and not PUCCH.

After step S180, the processing proceeds to step S190 where it is checked whether the index a is equal to (N−1). If yes, the processing ends (in this TTI). If no, the processing returns to step S120 so as to detect a further UE pair (two new UEs).

In the second, in step S200, a CQI collision measurement for the UE pair under investigation (UE corresponding to a and b) is updated. The CQI collision measurement may comprise, for example, the determination of a collision probability value indicating a probability that a collision between the UEs at the dedicated resource element happens. In the case of step S200, as a collision is detected, the collision probability is increased.

Then, step S210 is executed where it is determined whether the collision probability for the current UE pair (i.e. a and b) is higher than a predetermined threshold value. The threshold value represents, for example, an acceptable limit for a collision frequency (i.e. how often a collision between two UEs at the same resource element happens) and is set beforehand according to network specifications or the like.

If the decision in step S210 is negative, i.e. the threshold is not exceeded (the calculated collision probability is sufficiently low), the present cycle of the procedure ends.

Otherwise, in case the threshold is determined to be exceeded in step S210, step S220 follows. Step S220 represent a second processing for preventing a collision which is also referred to as a long term collision prevention processing.

In this long term collision prevention processing, basically, adjustments in the configuration of at least one (or all) of the UEs (identified by a and b) are effected. These adjustments may comprise, for example, changing of the reporting period (timing), changing scheduling settings (like setting another resource element), changing DRX parameters of the UE(s) and the like. By means of these changings, the collision probability is lowered since the transmission of the CQI is changed from the present timing or resource. Hence, by means of these measures, a certain collision target is to be achieved, wherein it is possible to use different targets for different services or user classes.

Furthermore, in step S220, the result of the CQI collision measurement for the respective UE pair may be reset.

It is to be noted that the measures or actions performed in the long term collision prevention processing may include a changing of CQI reporting settings and/or DRX settings, so that the collision probability is according to the (selected) target. However, as these actions typically require higher layer signaling, such as layer 3 or RRC signaling in LTE systems, it is preferable that corresponding measures are conducted not too frequent. This is achievable, for example, by suitable setting the threshold or target value regarding the collision probability.

After step S220, the processing also ends in this cycle.

It is to be noted that even though in the example according to FIG. 2 two UEs are compared (i.e. UE pair a and b), it is also possible to conduct the respective processing with more than two UEs.

Furthermore, regarding the two processing branches shown in FIG. 2 after step S140 (YES), it is also possible to consider a decision step between steps S180 and S200 deciding which one of the long term or short term collision prevention processes is to be conducted (i.e. the two branches are not processed in parallel but alternatively).

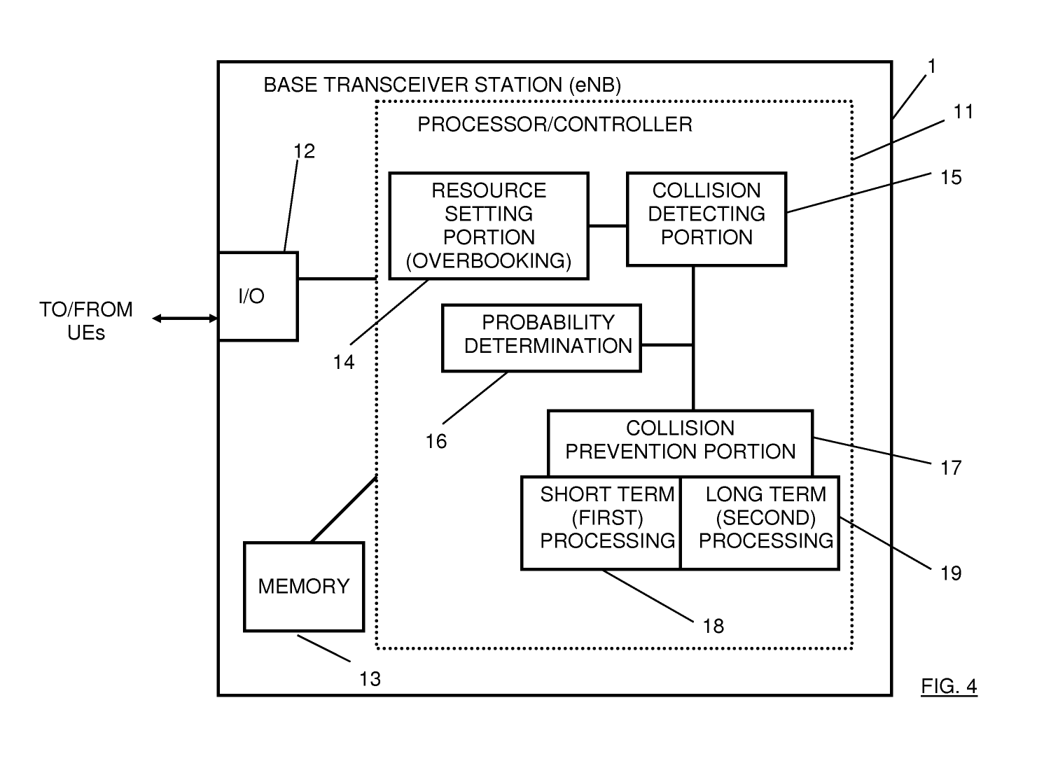

In FIG. 4, a block circuit diagram illustrating a configuration of a base transceiver station/eNB capable of executing a procedure for controlling a transmission of connection quality information according to an example of an embodiment of the invention is shown. It is to be noted that the shown network element may comprise several further elements or functions besides those described in connection with FIG. 4 which are omitted herein for the sake of simplicity as they are not essential for understanding the invention.

As shown in FIG. 4, the base transceiver station 1 configured to execute a transmission control procedure according to FIG. 1 or 2, for example, may comprise a processing function or processor or controller 11, such as a CPU or the like, which executes instructions given by programs or the like related to the resource setting scheme. The processor or controller 11 may comprise further portions dedicated to specific processings described below. However, the portions for executing these specific processings may be also provided as discrete elements or within one or more further processors, for example. Reference sign 12 denotes a transceiver or input/output (I/O) unit connected to the processor 11 (or corresponding other elements comprising the functions of the further portions). The I/O unit 12 may be used for communicating with one or more user equipments, such as UE1 to UE7 as shown in FIG. 3. The I/O unit 12 may also have a distributed structure with a plurality of different interfaces. Reference sign 13 denotes a memory usable, for example, for storing data and programs to be executed by the processor 11 (and/or the further portions dedicated to specific processings) and/or as a working storage of the processor 11 (and/or of the further portions dedicated to specific processings).

Regarding the portions for executing the specific processings related to the transmission control according to examples of embodiments of the invention, a resource setting processing portion 14 is provided which conducts a processing for assigning resource elements on PUCCH and PUSCH (scheduling of UEs connected to the eNB2) according to an initial setting and a changed setting (depending on a collision detection, for example), wherein for the initial setting an overbooking scheme as described above is used. Reference sign 15 denotes a collision detecting portion which is configured to detect whether a collision between transmissions of CQI or the like of two or more UEs occurs. Reference sign 16 denotes a collision probability determination portion which calculates and updates a collision probability between two (or more) UEs monitored by the collision detecting portion 15. Reference sign 17 denotes a collision prevention portion which conducts the collision prevention procedure when the collision detecting portion 15 predicts a (possible) collision. The collision prevention portion 17 comprises two further processing portions, i.e. a short term (first) processing portion configured to execute the processing related to the short term collision prevention scheme according to step S180 of FIG. 2, for example, and a long term (second) processing portion 19 configured to execute the processing related to the long term collision prevention scheme according to step S220 of FIG. 2, for example.

As described above, by means of the transmission control according to examples of embodiments of the invention, it is possible to use resources, such as PUCCH resources, more efficiently since overbooking is used. Fast and frequent CQI reporting for DRX users is achievable, so that the users have good scheduling performance whenever they are in active time, combined with a lowest possible uplink overhead. Several DRX users (where it is assumed from their traffic characteristics and configured DRX parameters) that are assumed not to have often an overlap between active times can then be configured to share the same PUCCH resources for CQI reporting. On the other hand, in case the collision detector determines that some users start to collide often, their CQI parameters can be modified.

For the purpose of the present invention as described herein above, it should be noted that
an access technology via which signaling is transferred to and from a network element or node, e.g. between a user equipment and a base transceiver station, may be any technology by means of which a node can access an access network (e.g. via a base station or generally an access node). Any present or future technology, such as WLAN (Wireless Local Access Network), WiMAX (Worldwide Interoperability for Microwave Access), BlueTooth, Infrared, and the like may be used; although the above technologies are mostly wireless access technologies, e.g. in different radio spectra, access technology in the sense of the present invention implies also wirebound technologies, e.g. IP based access technologies like cable networks or fixed lines but also circuit switched access technologies; access technologies may be distinguishable in at least two categories or access domains such as packet switched and circuit switched, but the existence of more than two access domains does not impede the invention being applied thereto,
usable access networks including the base transceiver station may be any device, apparatus, unit or means by which a station, entity or other user equipment may connect to and/or utilize services offered by the access network; such services include, among others, data and/or (audio-) visual communication, data download etc.;
a user equipment may be any device, apparatus, unit or means by which a system user or subscriber may experience services from an access network, such as a mobile phone, personal digital assistant PDA, a modem card or another computer based equipment;
method steps likely to be implemented as software code portions and being run using a processor at a network element or terminal (as examples of devices, apparatuses and/or modules thereof, or as examples of entities including apparatuses and/or modules therefor), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, apparatuses, units or processing portions likely to be implemented as hardware components at a terminal or network element, or any module(s) thereof, are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may for example be based on any security architecture capable e.g. of authentication, authorization, keying and/or traffic protection;
devices, apparatuses, units or means can be implemented as individual devices, apparatuses, units or means, but this does not exclude that they are implemented in a distributed fashion throughout the system, as long as the functionality of the device, apparatus, unit or means is preserved,
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

As described above, there is proposed a mechanism for controlling a transmission of a connection quality information, like CQI, from a UE to a base transceiver station via an uplink connection. Resources of an uplink control channel for the transmission of the connection quality information are set for a plurality of UEs. A collision between transmissions of the connection quality information by at least two user equipments of the plurality of UEs on a same resource element is detected or predicted on the basis of input information, and a collision prevention processing is executed when such collision is detected or predicted.

Although the present invention has been described herein before with reference to particular embodiments thereof, the present invention is not limited thereto and various modifications can be made thereto.

1. A method comprising
controlling a transmission of a connection quality information from a user equipment to a base transceiver station via an uplink connection,
setting resources of an uplink control channel for a plurality of user equipments, wherein resource elements of the resources of the uplink control channel are to be used for the transmission of the connection quality information by each of the plurality of user equipments,
detecting a collision between transmissions of the connection quality information by at least two user equipments of the plurality of user equipments on a same resource element of the set resources of the uplink control channel, and
executing a collision prevention processing when a collision is detected.

2. The method according to claim 1, wherein the setting of the resources comprises an overbooking in the uplink control channel with regard to the number of user equipments of the plurality of user equipments, wherein the overbooking is based on a specific overbooking factor.

3. The method according to claim 2, wherein the specific overbooking factor is determined on the basis of parameters comprising at least one of a traffic pattern value, an activity factor value, a value indicating quality of service constraints, and values indicating a discontinuous reception setting of the plurality of user equipments.

4. The method according to any of claim 1, wherein the detecting of a collision comprises estimating a possible collision beforehand by considering input information regarding the transmission of the connection quality information of each of the plurality of user equipments.

5. The method according to claim 4, wherein the input information comprises at least one of an indication regarding an active time of each of the plurality of user equipments, information of timer settings for the plurality of user equipments, information regarding scheduling of the plurality of user equipments, and information regarding the settings of the plurality of user equipments concerning the transmission of the connection quality information to the base transceiver station.

6. The method according to any of claim 1, wherein the collision prevention processing comprises at least one of
a first processing comprising a change of a setting of resources for a transmission of the connection quality information by at least one user equipment of the plurality of user equipments from a resource at the uplink control channel to a resource at an uplink shared channel, and
a second processing comprising a change of a configuration of at least one of the plurality of user equipments regarding the transmission of the connection quality information.

7. The method according to claim 6, wherein the first processing further comprises
selecting one of the at least two user equipments involved in the collision between transmissions of the connection quality information, wherein a setting of the re-sources for the transmission of the connection quality information of the selected user equipment is maintained.

8. The method according to claim 1, further comprising
determining a collision probability on the basis of a result of the detecting of the collision.

9. The method according to claim 6, further comprising
determining a collision probability on the basis of a result of the detecting of the collision, wherein the second processing is executed in the collision prevention processing when the collision probability exceeds a predetermined threshold.

10. The method according to claim 1, wherein the uplink connection comprises at least one of a physical uplink control channel and a physical uplink shared channel.

11. The method according to claim 1, wherein the connection quality information is a channel quality indicator (CQI).

12. The method according to claim 1, wherein the detecting of a collision is executed on a media access control layer.

13. An apparatus comprising
a controller configured to control a transmission of a connection quality information from a user equipment to a base transceiver station via an uplink connection,
a resource setter adapted to set resources of an uplink control channel for a plurality of user equipments, wherein resource elements of the resources of the uplink control channel are to be used for the transmission of the connection quality information by each of the plurality of user equipments,
a collision detector configured to detect a collision between transmissions of the connection quality information by at least two user equipments of the plurality of user equipments on a same resource element of the set resources of the uplink control channel, and
a collision preventor configured to execute a collision prevention processing when a collision is detected.

14. The apparatus according to claim 13, wherein the resource setter further comprises an overbooking processor portion configured to execute an overbooking processing in the uplink control channel with regard to the number of user equipments of the plurality of user equipments, wherein the overbooking processing is based on a specific overbooking factor.

15. The apparatus according to claim 14, wherein the overbooking processor portion is further configured to determine the specific overbooking factor on the basis of parameters comprising at least one of a traffic pattern value, an activity factor value, a value indicating quality of service constraints, and values indicating a discontinuous reception setting of the plurality of user equipments.

16. The apparatus according to claim 13, wherein the collision detector further comprises
an estimator configured to estimate a possible collision beforehand by considering input information regarding the transmission of the connection quality information of each of the plurality of user equipments.

17. The apparatus according to claim 16, wherein the input information comprises at least one of an indication regarding an active time of each of the plurality of user equipments, information of timer settings for the plurality of user equipments, information regarding scheduling of the plurality of user equipments, and information regarding the settings of the plurality of user equipments concerning the transmission of the connection quality information to the base transceiver station.

18. The apparatus according to claim 13, wherein the collision preventor comprises at least one of
a first processing portion configured to change a setting of resources for a transmission of the connection quality information by at least one user equipment of the plurality of user equipments from a resource at the uplink control channel to a resource at an uplink shared channel, and
a second processing portion configured to change a configuration of at least one of the plurality of user equipments regarding the transmission of the connection quality information.

19. The apparatus according to claim 18, wherein the first processing portion is further configured to
select one of the at least two user equipments involved in the collision between transmissions of the connection quality information, wherein a setting of the resources for the transmission of the connection quality information of the selected user equipment is maintained.

20. The apparatus according to claim 13, further comprising a probability determiner configured to determine a collision probability on the basis of a result obtained by the collision detector.

21. The apparatus according to claim 18, further comprising a probability determiner configured to determine a collision probability on the basis of a result obtained by the collision detector, wherein the second processing portion is further configured to execute the collision prevention processing when the collision probability exceeds a predetermined threshold.

22. The apparatus according to claim 13, wherein the uplink connection comprises at least one of a physical uplink control channel and a physical uplink shared channel.

23. The apparatus according to claim 13, wherein the connection quality information is a channel quality indicator (CQI).

24. The apparatus according to claim 13, wherein the collision detector operates on a media access control layer.

25. A computer program product for a computer, comprising software code portions for performing the steps of claim 1 when said product is run on the computer.

26. A computer program product according to claim 25, wherein said computer program product comprises a computer readable medium on which said software code portions are stored.

27. A computer program product according to claim 25, wherein said computer program product is directly loadable into the internal memory of the computer.
